(19) United States
(12) Patent Application Publication
(10) Pub. No.: US 2020/0265414 A1
(43) Pub. Date: Aug. 20, 2020

(54) METHODS, SYSTEMS AND COMPUTER PROGRAM PRODUCTS FOR SPLIT PAYMENT CARD ACCOUNT TRANSACTIONS

(71) Applicant: Mastercard International Incorporated, Purchase, NY (US)

(72) Inventors: Akshay KORANNE, Pune (IN); Ketan Shrikant JOSHI, Pune (IN); Gaurav K. PATNI, Pune (IN)

(21) Appl. No.: 16/744,864

(22) Filed: Jan. 16, 2020

(30) Foreign Application Priority Data
Feb. 18, 2019 (IN) 201911006252

(51) Int. Cl. G06Q 20/34; G06Q 20/40

(52) U.S. Cl. CPC G06Q 20/34; G06Q 20/401

(57) ABSTRACT

The invention relates to methods, systems and computer program products for splitting a transaction payment between multiple payment cards or accounts while simultaneously availing of installment repayment facilities. The invention involves (i) receiving from a terminal device, information describing a payment transaction for implementation based on the plurality of payment card accounts, (ii) obtaining from each issuer, authorization for disbursement of a corresponding payment tranche, (iii) obtaining from one or more issuers associated, installment repayment arrangements offered by said one or more issuers, (iv) receiving from the terminal device, information identifying installment repayment arrangements that have been accepted by a payor, and (v) storing in a database, the information describing the payment transaction and the information identifying the one or more installment repayment arrangements that have been accepted by the payor.

### FIELD OF THE INVENTION

The present invention relates to the field of payment card based electronic payment transactions, and more specifically to methods and systems for splitting a transaction payment between multiple payment cards while simultaneously availing of installment repayment facilities in respect of the transaction amount that is paid through at least one of said multiple payment cards.

### BACKGROUND OF THE INVENTION

Electronic transactions and payments using payment card accounts are increasingly common—with the number of electronic payment transactions and ubiquity of electronic transaction mechanisms and services growing steadily.

FIG. 1 illustrates a prior art system environment 100 that can be used for implementing electronic transactions based on a payment card or payment card information presented by a card holder at a terminal device 102. In certain embodiments of the present invention, system 100 may be modified to implement the invention. System 100 includes terminal device 102, acquirer network 104, card network 106 and issuer network 108. While FIG. 1 has been used to illustrate a payment card based network, it would be understood that similar principles and one or more entities having some or all of the same functions may be used to effect payments through any electronic transaction account.

Acquirer network 104 may be communicably coupled with terminal device 102, and comprises acquirer server 104a, acquirer network database 104b and interface gateway 104c. Acquirer server 104a may be configured to receive and process information relating to payment card transactions. In an embodiment, the acquirer network may receive or process transactions received only from merchants having a merchant account with the acquirer—which determination may be made based on information retrieved from acquirer network database 104b. Interface gateway 104c may include a hardware or software network gateway configured to enable acquirer network 104 to communicate with card network 106.

Card network 106 may be communicably coupled to both acquirer network 104 and issuer network 108.

Issuer network 108 comprises issuer server 108a, issuer network database 108b and interface gateway 108c. Issuer server 108a may be configured to receive and process information relating to payment card transactions. In an embodiment, the issuer network may only receive or process transactions involving payment card holders having an account with the issuer—which determination may be made based on information retrieved from issuer network database 108b. Interface gateway 108c may include a hardware or software network gateway configured to enable issuer network 108 to communicate with card network 106.

Terminal device 102 may comprise any terminal device including without limitation a POS terminal device 102a, computing device 102b, or mobile phone or smartphone 102c.

It is also common that users of payment cards or payment card accounts may have more than one such payment card or payment card account. In some cases, a payor may find it desirable to split a purchase transaction between two or more of her/his payment card accounts.

In the system environment of FIG. 1, card network 106 may be configured to enable a payor to split a transaction payment between multiple payment card accounts.

FIG. 2 illustrates an exemplary sub-system 200 within payment network 206, comprising payment network server 202 communicably coupled with split payment server 204. In the illustrated embodiment, payment network server 202 may receive from a terminal device (i) information regarding a payment transaction which requires to be split across multiple payment card accounts, (ii) information regarding the payment cards or payment card accounts across which the payment transaction requires to be split and (iii) information regarding payment amounts to be respectively associated with or paid through each payment card or payment account. The received information is transmitted to split payment server 204, which may be configured to record all or part of the received information, and to route appropriate payment requests to individual issuer banks with which the identified payment card accounts are associated, with a view to ensure that the share of each payment card account is appropriately transferred from such account to a designated transaction payee.

It has however been found that existing methods for splitting payment transactions do not enable a payor to avail of installment repayment plans offered by issuer institutions associated with the payment card accounts being used for the split payment transaction. This has been found to be a disadvantage to payors, payees, issuer institutions and payment networks. Availability of installment repayment plans is often critical to the purchasing ability of a payor. This is even more the case where the transaction amount is large—which is statistically a more likely case where a transaction amount is being split by the payor across multiple payment card accounts—and lack of installment repayment options would significantly reduce the likelihood of the payor going forward with the transaction. The disincentive for a payor to enter into payment transactions has the obvious effect of reducing revenues for merchants. Simultaneously, issuer institutions and payment networks also suffer a revenue loss from lost transaction charges that would otherwise arise from a transaction, and additionally lose interest that could otherwise accrue if the payor had availed of an installment repayment facility.

There is accordingly a need for enabling a payor to avail of installment repayment facilities while making a transaction payment through a split payment transaction arrangement.

### SUMMARY

The invention relates to methods, systems and computer program products for splitting a transaction payment between multiple payment cards or payment card accounts while simultaneously availing of installment repayment facilities in respect of the transaction amount that is paid through at least one of said multiple payment cards or payment card accounts.

The invention provides a system for implementing a payment transaction split across a plurality of payment card accounts. The system comprises a processor implemented split payment server configured to (i) receive from a terminal device, information describing a payment transaction for implementation based on the plurality of payment card accounts, said information including at least (a) information identifying a total payment transaction amount, (b) information identifying the plurality of payment card accounts, and (c), information identifying payment tranches within the total payment transaction amount that is intended to be paid from each of the identified plurality of payment card accounts, (ii) obtain from each issuer respectively associated with each of the plurality of payment card accounts, issuer authorization for disbursement of a payment tranche that comprises part of the total payment transaction amount that is intended to be paid from said payment card account, (iii) obtain from one or more issuers associated with one or more of the plurality of payment card accounts, information defining one or more installment repayment arrangements offered by said one or more issuers in connection with the payment tranches that have been authorized for disbursement by said one or more issuers, (iv) receive from the terminal device, information identifying one or more of the installment repayment arrangements that have been accepted by a payor, and (v) retrievably store in a database, the information describing the payment transaction and the information identifying the one or more installment repayment arrangements that have been accepted by the payor.

In an embodiment of the system, the information describing the payment transaction for implementation based on the plurality of payment card accounts, includes information comprising (i) a payor identifier, (ii) a merchant identifier or merchant account identifier, and (iii) information indicating that payment transaction is a payment transaction intended to be split across a plurality of payment card accounts.

The system may be configured such that (i) the one or more installment repayment arrangements offered by one or more issuers in connection with the payment tranches that have been authorized for disbursement by said one or more issuers are transmitted to the terminal device for display to the payor, and (ii) the information identifying one or more of the installment repayment arrangements that have been accepted by the payor, is received through inputs at the terminal device.

In an embodiment of the system, the split payment server is configured to (i) receive from a point-of-sale (POS) terminal, a payment transaction execution instruction, and (ii) responsive to determining that the payment transaction execution instruction corresponds to a stored payment transaction authorization relating to a payment transaction intended to be split across a plurality of payment card accounts (a) identify a payment card issuer corresponding to each payment card account involved in the authorized payment transaction, (b) retrieve installment repayment information corresponding to one or more issuer specific payment tranches associated with the authorized payment transaction, (c) transmit to each identified payment card issuer, a payment implementation request, for implementing transfer of the specific payment tranche amount associated with said payment card issuer, from a payment card account of the payor to a merchant account, and (d) transmit to at least one of said payment card issuers associated with individual payment tranches, information identifying an installment repayment arrangement that has been offered by said payment card issuer to the payor and which installment repayment arrangement has been accepted by the payor in connection with the payment tranche associated with such payment card issuer.

In a system embodiment, the payment transaction execution instruction includes one or more of information identifying one or more payment card accounts, a payment amount, a merchant identifier, and payor identity authentication information.

The system may be configured such that a determination that the payment transaction execution instruction corresponds to a stored payment transaction authorization relating to a payment transaction intended to be split across a plurality of payment card accounts, is based on identifying a match between data parameters corresponding to the payment transaction execution instruction and data parameters corresponding to one or more stored payment transaction authorizations relating to payment transactions intended to be split across a plurality of payment card accounts.

The invention additionally provides a method for implementing a payment transaction split across a plurality of payment card accounts. The method comprises, at a split payment server (i) receiving from a terminal device, information describing a payment transaction for implementation based on the plurality of payment card accounts, said information including at least (a) information identifying a total payment transaction amount, (b) information identifying the plurality of payment card accounts, and (c), information identifying payment tranches within the total payment transaction amount that is intended to be paid from each of the identified plurality of payment card accounts, (ii) obtaining from each issuer respectively associated with each of the plurality of payment card accounts, issuer authorization for disbursement of a payment tranche that comprises part of the total payment transaction amount that is intended to be paid from said payment card account, (iii) obtaining from one or more issuers associated with one or more of the plurality of payment card accounts, information defining one or more installment repayment arrangements offered by said one or more issuers in connection with the payment tranches that have been authorized for disbursement by said one or more issuers, (iv) receiving from the terminal device, information identifying one or more of the installment repayment arrangements that have been accepted by a payor, and (v) retrievably storing in a database, the information describing the payment transaction and the information identifying the one or more installment repayment arrangements that have been accepted by the payor.

In an embodiment of the method, the information describing the payment transaction for implementation based on the plurality of payment card accounts, includes information comprising (i) a payor identifier, (ii) a merchant identifier or merchant account identifier, and (iii) information indicating that payment transaction is a payment transaction intended to be split across a plurality of payment card accounts.

In another method embodiment, (i) the one or more installment repayment arrangements offered by one or more issuers in connection with the payment tranches that have been authorized for disbursement by said one or more issuers are transmitted to the terminal device for display to the payor, and (ii) the information identifying one or more of the installment repayment arrangements that have been accepted by the payor, is received through inputs at the terminal device.

In a specific embodiment, the method includes (i) receiving from a point-of-sale (POS) terminal, a payment transaction execution instruction, (ii) responsive to determining that the payment transaction execution instruction corresponds to a stored payment transaction authorization relating to a payment transaction intended to be split across a plurality of payment card accounts (a) identifying a payment card issuer corresponding to each payment card account involved in the authorized payment transaction, (b) retrieving installment repayment information corresponding to one or more issuer specific payment tranches associated with the authorized payment transaction, (c) transmitting to each identified payment card issuer, a payment implementation request, for implementing transfer of the specific payment tranche amount associated with said payment card issuer, from a payment card account of the payor to a merchant account, and (d) transmitting to at least one of said payment card issuers associated with individual payment tranches, information identifying an installment repayment arrangement that has been offered by said payment card issuer to the payor and which installment repayment arrangement has been accepted by the payor in connection with the payment tranche associated with such payment card issuer.

In a method embodiment, the payment transaction execution instruction includes one or more of information identifying one or more payment card accounts, a payment amount, a merchant identifier, and payor identity authentication information.

In a particular embodiment of the method, a determination that the payment transaction execution instruction corresponds to a stored payment transaction authorization relating to a payment transaction intended to be split across a plurality of payment card accounts, is based on identifying a match between data parameters corresponding to the payment transaction execution instruction and data parameters corresponding to one or more stored payment transaction authorizations relating to payment transactions intended to be split across a plurality of payment card accounts.

The invention additionally provides a computer program product for implementing a payment transaction split across a plurality of payment card accounts. The computer program product comprises a non-transitory computer usable medium having a computer readable program code embodied therein, the computer readable program code comprising instructions for implementing within a processor based computing system, one or more of (i) receiving from a terminal device, information describing a payment transaction for implementation based on the plurality of payment card accounts, said information including at least (a) information identifying a total payment transaction amount, (b) information identifying the plurality of payment card accounts, and (c), information identifying payment tranches within the total payment transaction amount that is intended to be paid from each of the identified plurality of payment card accounts, (ii) obtaining from each issuer respectively associated with each of the plurality of payment card accounts, issuer authorization for disbursement of a payment tranche that comprises part of the total payment transaction amount that is intended to be paid from said payment card account, (iii) obtaining from one or more issuers associated with one or more of the plurality of payment card accounts, information defining one or more installment repayment arrangements offered by said one or more issuers in connection with the payment tranches that have been authorized for disbursement by said one or more issuers, (iv) receiving from the terminal device, information identifying one or more of the installment repayment arrangements that have been accepted by a payor, and (v) retrievably storing in a database, the information describing the payment transaction and the information identifying the one or more installment repayment arrangements that have been accepted by the payor.

### BRIEF DESCRIPTION OF THE ACCOMPANYING DRAWINGS

FIG. 1 illustrates a prior art system environment for authenticating and implementing electronic transactions through a payment card transaction system.

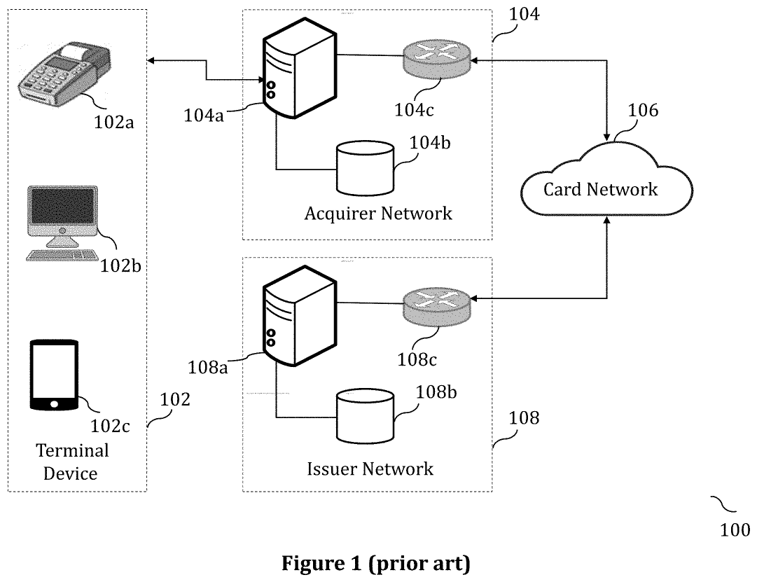

FIG. 2 illustrates payment network components of the system environment of FIG. 1.

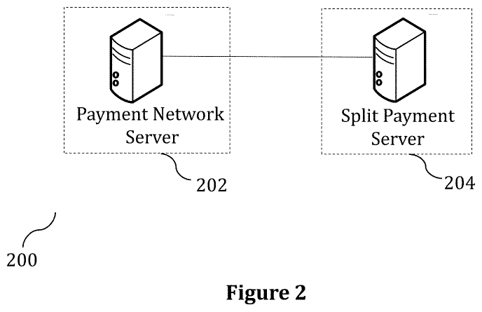

FIG. 3 illustrates a system environment for obtaining authorization for a split payment transaction in accordance with the present invention.

FIG. 4 illustrates a method for obtaining authorization for a split payment transaction involving an installment repayment arrangement with at least one issuer institution.

FIG. 5 illustrates communication flow between network system entities for implementing the method of FIG. 4.

FIG. 6 illustrates an exemplary data structure that may be implemented for storing data records generated in implementing the method of FIG. 4.

FIG. 7 illustrates a method for executing a split payment transaction involving an installment repayment arrangement with at least one issuer institution.

FIG. 8 illustrates communication flow between network system entities for implementing the method of FIG. 7.

FIG. 9 illustrates an exemplary embodiment of a split payment server.

FIG. 10 illustrates an exemplary computer system according to which various embodiments of the present invention may be implemented.

### DETAILED DESCRIPTION

The present invention provides mechanisms for enabling a payor to avail of installment repayment options while making a transaction payment through a split payment transaction arrangement.

For the purposes of the present invention, the following terms shall be understood to have the corresponding meanings provided below:

“Acquirer” or “Acquirer Institution” shall mean a business (e.g., a financial institution or a merchant bank) that contracts with a merchant to coordinate with the issuer network of a customers' payment card.

“Acquirer network” shall refer to a communication network, including hardware, software and other equipment used by an acquirer to transmit and process card based transactions and information related to merchants, customers, payment cards and transactions.

“Card holder” or “Customer” shall mean an authorized payment card user who is making a purchase or effecting an electronic transaction with a payment card.

“Card network” shall refer to the intermediary between the merchant's acquirer and the customer's issuer (for example, Mastercard® or Visa®). The card network primarily coordinates payment card transactions between acquirers and issuers, and additionally coordinates clearing and settlement services to transfer payments from issuers to merchants.

“Issuer” or “Issuer Institution” shall mean a financial institution that issues payment cards and maintains a contract with a customer or card holder for repayment or settlement of purchases made on the payment card.

“Issuer network” shall refer to a communication network, including hardware, software and other equipment used by an issuer to transmit and process payment card transactions and information related to customers, payment cards and transactions.

“Merchant” shall mean an authorized acceptor of payment cards for the payment of goods or services sold by the merchant.

“Payment account” shall mean any account that may be used for the purposes of effecting an electronic payment or electronic transaction, and shall include any electronic transaction account, payment card account, bank account or electronic wallet account.

“Payment card” shall mean a card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

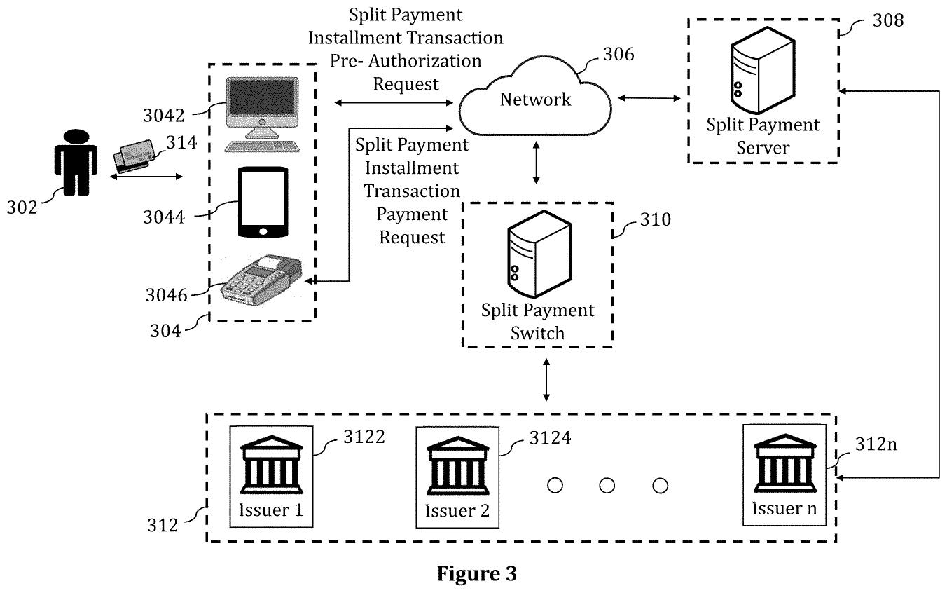

FIG. 3 illustrates a system environment for obtaining authorization for a split payment transaction in accordance with the present invention.

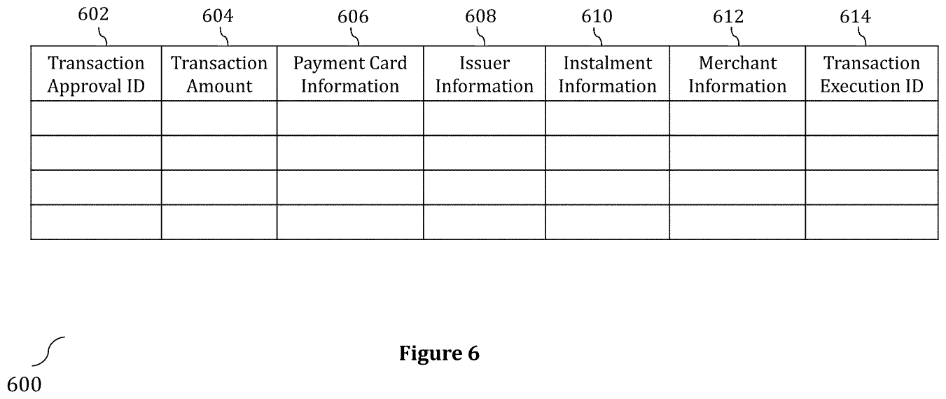

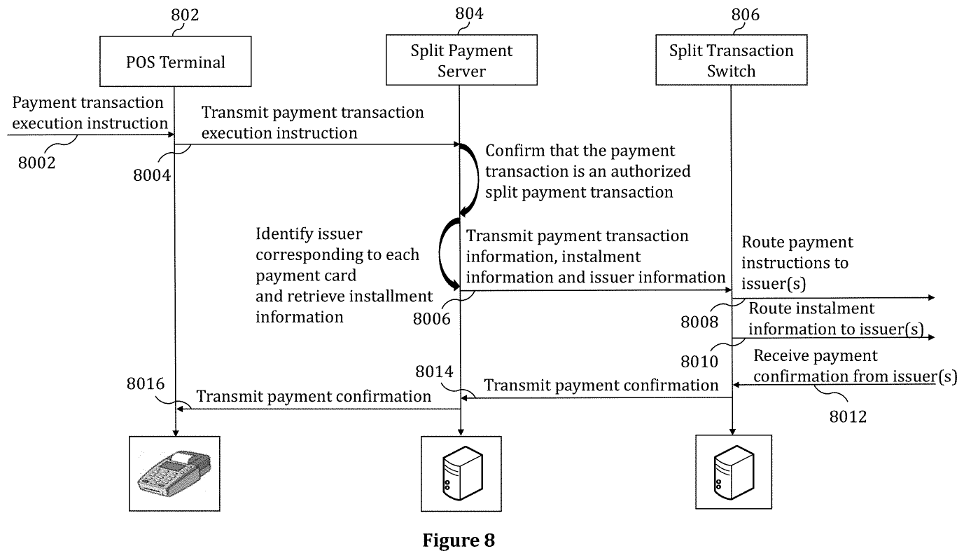

System environment 300 includes payor 302 having a plurality of payment cards 314. Payor 302 may have access to a terminal device 304 through which payor 302 may request authorization (or pre-authorization) of a split payment transaction in accordance with the teachings of the present invention. Terminal device 304 may comprise any processor implemented data processing device having network communication capabilities, and may in certain embodiments comprise a computing device 3042, a smartphone 3044, a point-of-sale terminal 3046, or other network communication enabled mobile device. Terminal device 304 may be communicably coupled through network 306 (which network 306 may in an embodiment comprise a payment network) with a split payment server 308 of the type discussed in more detail subsequently in this written description, and which split payment server 308 may be configured (i) to receive from terminal device 304 requests for authorization or pre-authorization of a split payment transaction that is intended to be executed by payor 302 using a sub-set of said payor's plurality of payment cards 314, and (ii) to obtain from issuers corresponding to the sub-set of payment cards, approval or rejection of the individual payment tranches associated with each payment card within the overall split payment transaction. Split payment server 308 may additionally be configured (i) to obtain and transmit from each approving issuer associated with a requested split payment transaction, installment repayment arrangements or offers that the approving issuer is willing to offer to the payor 302, and (ii) to obtain from payor 302, input identifying one or more installment repayment arrangements or offers that the payor selects or accepts in connection with the approved split payment transaction. In various embodiments, split payment server 308 may be configured to implement at least one of the methods of FIG. 6 or 8 that are discussed in more detail below. Split payment server 308 may be located within network 306 (which may in certain embodiments comprise a payment network associated with at least one of the payor's payment cards or payment card accounts) or may be external to network 306. Once a split payment transaction and corresponding installment repayment arrangements have been approved and selected for implementation by a payor 302, said payor 302 may initiate a transaction implementation request from POS terminal 3046, to make payment of a transaction amount (that has been previously authorized as a split payment transaction involving installment repayment arrangement(s)) to a merchant associated with POS terminal 3046.

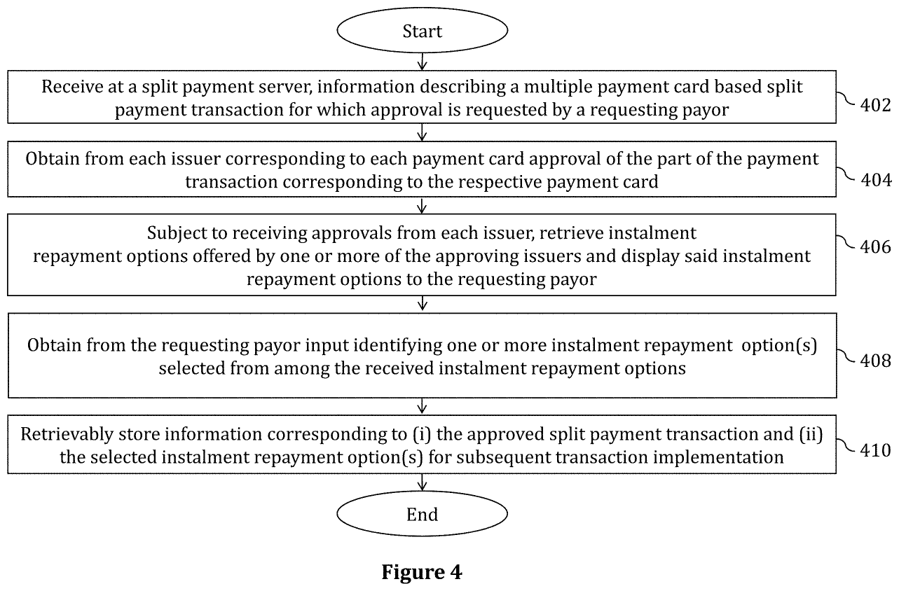

Execution of the split payment transaction may involve (i) identifying or confirming, based on transaction information received from POS terminal 3046, that the payment transaction is a split payment transaction that has been previously authorized through split payment server 308, (ii) routing through split payment switch 310, payment instructions to each issuer 312 (i.e. to issuers selected from among issuers 1 to n (3122, 3124, 312n)) that corresponds to the payment card accounts involved in the split payment transaction—said instructions including information identifying a respective payment tranche that such issuer is responsible for implementing within the overall split payment transaction, and (iii) informing at least one (and optionally more than one) of said issuers, regarding the installment repayment arrangement(s) that has been selected or accepted by payor 302 for the purpose of repaying the payment made by such issuer on behalf of the payor as part of the split payment transaction implementation. Specific implementations of the manner in which system environment 300 functions, and the manner in which split payment transactions are authorized and implemented in accordance with the present invention, are discussed in connection with FIGS. 4 to 9 below.

FIG. 4 illustrates a method for obtaining authorization for a split payment transaction involving an installment repayment arrangement with at least one issuer institution. In an embodiment, the method of FIG. 4 may be implemented within system environment 300, and more particularly within split payment server 308.

Step 402 comprises receiving at split payment server 308, information describing a multiple payment card/payment card account based split payment transaction for which authorization is being requested by payor 302. The request for authorization may be initiated by payor 302 at terminal device 304, and the information received at the split payment server 308 may include information describing a multiple payment card account based split payment transaction for which authorization is being requested. Said information may be received by way of input at terminal device 304. The information received at split payment server 308 may include one or more of (i) a payor identifier, (ii) a transaction amount, (iii) a merchant identifier or merchant account identifier, (iv) information indicating that the authorization is being requested in respect of a split payment transaction, (iv) information identifying a plurality of payment card accounts among which the payment transaction amount requires to be split, and (v) information identifying specific shares or payment tranches of the overall split transaction payment amount that the payor 302 intends to pay from each of the identified plurality of payment card accounts. The request for authorization and the information describing a multiple payment card based split payment transaction for which authorization is being requested may be transmitted from terminal device 304 to split payment server 308 through payment network 306 or through any other communication network.

Step 404 comprises obtaining from each issuer corresponding to each payment card account identified at step 402 (i.e. identified as being involved in the requested split payment) transaction authorization of the respective payment tranche that the payor 302 intends to effect through her/his payment card account maintained with said issuer. It would be understood that each issuer authorization may be conditional on one or more factors, including satisfactory identity authentication, ascertaining that the payor is authorized to carry out the desired payment transaction from the corresponding payment card account, and ascertaining that the payment card account has a sufficient available balance to permit the specified payment tranche amount to be transferred. Responsive to each issuer determining that the requested payment tranche amount can be paid from the payor's payment card account maintained with said issuer, said issuer may transmit a payment authorization message to split payment server 308.

At step 406, subject to receiving authorizations from each issuer, authorizing payment of the corresponding payment tranche amount from the payor's respective payment card accounts maintained with such issuer(s), split payment server 308 retrieves from (or receives from) one or more of the issuers, information comprising any installment repayment options or arrangements offered by said issuer(s) in respect of the payment tranche amount for which such issuer has granted authorization to payor 302. The information received at step 406 may include one or more installment repayment plan identifiers that define an installment repayment arrangement for the payor 302 to repay to the issuer, the concerned payment tranche amount. Non-limiting installment repayment plan identifiers may include an interest rate, a number payment periods, a payment installment amount or a pointer to an entry in a database where such information is stored. It would be understood that the information comprising installment repayment options or arrangements that is received at split payment server 308 may comprise installment repayment option(s) offered by one or more than one of the issuers involved in the split payment transaction—each issuer providing information identifying installment repayment options that such issuer is offering payor 302 in respect of the payment tranche amount for which that issuer has granted payor 302 the transaction payment authorization.

Step 408 comprises obtaining from the payor who initiated the split payment transaction authorization request (i.e. payor 302), input identifying one or more installment repayment option(s) selected by said payor 302 from among the installment repayment options received by split payment server 308 at step 406. In one embodiment, step 408 may comprise a prior step of displaying to payor 302 on terminal device 304, the installment repayment options received by split payment server 308 at step 406, and prompting payor 302 to provide input selecting one, more than one or none of the displayed installment repayment options. Payor 302 may provide the necessary input(s) through terminal device 304, and said input(s) or information corresponding to said input(s) and identifying one or more selected installment repayment options may be transmitted from terminal device 304 to split payment server 308.

Step 410 comprises retrievably storing information corresponding to (i) the authorized split payment transaction and (ii) the installment repayment option(s) selected by payor 302—for subsequent transaction implementation. In an embodiment, said information is stored by split payment server 308 in a database that may be internal or external to split payment server 308. The stored information may be retrieved for subsequent use at the time of execution of the split payment transaction that has been authorized in accordance with the method steps of FIG. 4.

FIG. 6 illustrates an exemplary data structure 600 that may be implemented for storing data records or information generated at step 410 of FIG. 4. As illustrated, data structure 600 may comprise one or more of (i) data field 602 configured to store a transaction approval ID uniquely corresponding to the split payment transaction that has been authorized in accordance with the teachings of FIG. 4, (ii) data field 604 configured to store a payment amount (i.e. the total payment amount) associated with the authorized split payment transaction, (iii) data field 606 configured to store information corresponding to each of the plurality of payment cards or payment card accounts that have been identified for implementing the authorized split payment transaction—and which may include a payment card identifier or payment card account identifier, and/or a payment tranche or a part of the total split payment transaction amount that is associated with the payment card or payment card account (iv) data field 608 configured to store issuer information corresponding to each of the plurality of payment cards or payment card accounts that have been identified for implementing the authorized split payment transaction—and which may include at least an issuer identifier, (v) data field 610 configured to store installment information corresponding to one or more installment repayment arrangements that have made available to the payor for a corresponding split payment transaction and which have been selected by the payor for the purposes of the split payment transaction—and further, which may include one or more repayment plan identifiers of the type discussed in connection with step 406 of FIG. 4 above, (vi) data field 612 configured to store merchant information identifying a merchant to whom the authorized split payment transaction is intended to be made, and (vii) data field 614 configured, upon execution and completion of the split payment transaction, to store a transaction execution identifier uniquely associated with the completed split payment transaction.

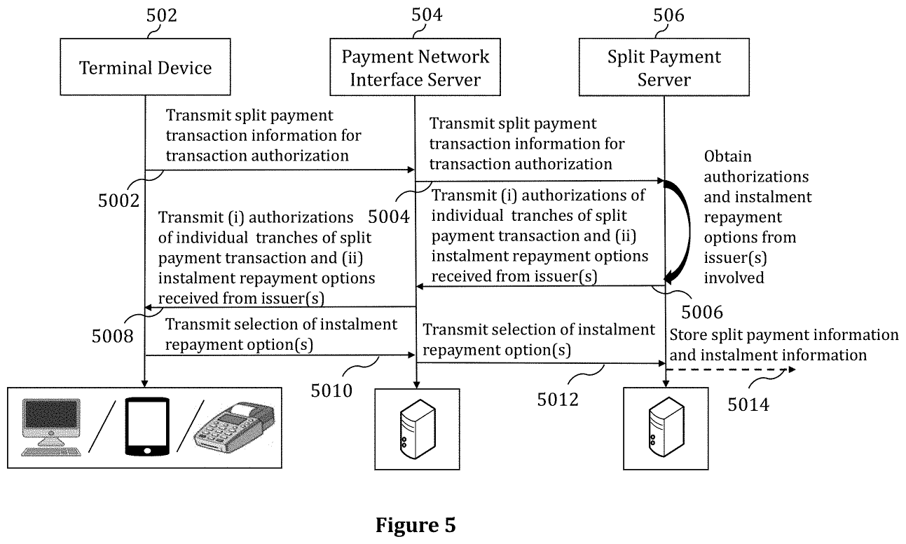

FIG. 5 illustrates communication flow between network system entities for implementing the method of FIG. 4.

Step S002 comprises transmitting from terminal device 502 to a payment network interface server 504 located within a payment network that is communicably coupled with terminal device 502, split payment transaction information for transaction authorization. The transmitted information may include one or more of (i) a payor identifier, (ii) a transaction amount, (iii) a merchant identifier or merchant account identifier, (iv) information indicating that the authorization is being requested in respect of a split payment transaction, (iv) information identifying a plurality of payment card accounts among which the payment transaction amount requires to be split, and (v) information identifying specific payment shares or payment tranches that the payor intends to pay from each of the identified plurality of payment card accounts.

At step S004, the information received at payment network interface server 504 is transmitted onward to split payment server 506, which may in an embodiment be located external to the payment network.

Split payment server 506 thereafter obtains authorizations for each payment tranche of the split payment transaction that is associated with a separate payment card account, and obtains information regarding any available installment repayment options that are offered by the respective issuer(s) to the payor in respect of one or more of said payment tranches. It would be understood that this step may be implemented in accordance with the teachings of steps 404 and 406 of FIG. 4.

Thereafter at step S006, split payment server 506 transmits to payment network interface server 504, (i) authorizations of individual tranches of the split payment transaction and (ii) installment repayment options received from issuers that have offered to the payor, installment repayment options in connection with their respective payment tranches within the split payment transaction. Step S008 comprises transmitting the data received at step S006 from payment network interface server 504 to terminal device 502—so that the received data may be displayed to the payor.

At step S010, terminal device 502 transmits to payment network interface server 504, data identifying one or more installment repayment options that have been offered by issuer institutions in respect of the split payment transaction and which have been accepted by the payor for the purposes of the intended split payment transaction—and at step S012, this data is transmitted onward to split payment server 506.

At step S014, split payment server 506 retrievably stores information corresponding to (i) the approved split payment transaction and (ii) the installment repayment option(s) selected by the payor—for subsequent transaction implementation. In an embodiment, said information may be stored by split payment server 506 in a database that may be internal or external to split payment server 506. The stored information may be retrieved for subsequent use at the time of execution of the split payment transaction that has been authorized.

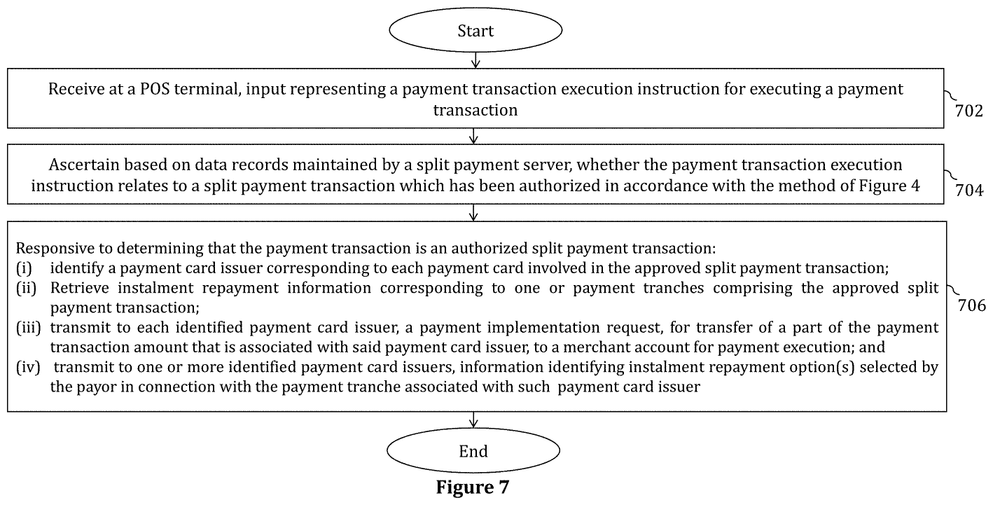

FIG. 7 illustrates a method for executing a split payment transaction involving an installment repayment arrangement with at least one issuer institution. The method of FIG. 7 involves execution of a split payment transaction for which a payor has already obtained authorization and has selected one or more installment repayment arrangements in accordance with the teachings of FIGS. 4 to 6 as discussed above. In a particular embodiment, the method of FIG. 7 may be implemented within system environment 300 of FIG. 3.

Step 702 comprises receiving through a POS terminal, input representing a payment transaction execution instruction for executing a payment transaction. The input may take any form sufficient to convey a definitive instruction to initiate a payment instruction. In an embodiment, the input may comprise receiving at POS terminal 3046 (i) information identifying at least a payment card or payment card account intended to be used for the purposes of the payment transaction (for example, through a card-swipe event at a magnetic stripe reader of the POS terminal or through a card-tap event at a wireless card reader of the POS terminal or through input of a payment card account number or other identifier), and (ii) optionally one or more additional payment transaction parameters including a payment amount, a merchant identifier, and payor identity authentication information (for example, a password, passcode, on-time-password (OTP) or personal identification number (PIN)). The information at step 702 may in an embodiment be received at split payment server 308, to which it may have been transmitted by POS terminal 3046 through network 306.

At step 704, split payment server 308 ascertains based on data records maintained by it (for example within data records stored in accordance with step 410 of FIG. 4), whether the payment transaction execution instruction relates to a split payment transaction that has been authorized in accordance with the method of FIG. 4. The determination at step 704 may be effected by comparing the information received at step 702 against the data records maintained by split payment server, and responsive to finding a match, concluding that the payment transaction execution instruction relates to a payment transaction execution instruction that has been authorized in accordance with the method of FIG. 4.

In one embodiment of the invention, the determination at step 704 results in a match if the information received at step 702, including (i) at least payment card information or payment account information identifying all payment cards or payment accounts that are associated (for example, within data records maintained by split payment server 308) with an authorized split payment transaction, and (ii) optionally one or more of (a) a total payment amount that matches a total payment amount recorded within the data records maintained by split payment server 308 in connection with an authorized split payment transaction, (b) a merchant identifier that matches a merchant identifier recorded within the data records maintained by split payment server 308 in connection with an authorized split payment transaction, and (c) individual payment tranche information associated with each issuer involved in the requested split payment transaction—matches corresponding information that has been recorded within data records maintained by split payment server 308 in connection with an authorized split payment transaction.

Thereafter at step 706, responsive to determining that the payment transaction is an authorized split payment transaction, split payment server 308 (i) identifies a payment card issuer corresponding to each payment card or payment card account involved in the approved split payment transaction, (ii) retrieves installment repayment information corresponding to one or more issuer specific payment tranches associated with the split payment transaction under implementation, (iii) transmits to each identified payment card issuer, a payment implementation request, for implementing transfer of the specific payment tranche amount that is associated with said payment card issuer from a payment card account of the payor to a merchant account, and (iv) transmits to at least one (and optionally more than one) of the payment card issuers associated with individual payment tranches within the total split payment transaction amount, information identifying an installment repayment option(s) that has been offered by said payment card issuer to the payor in connection with the split payment transaction under implementation, and which installment repayment option has been accepted or selected by the payor in connection with the payment tranche associated with such payment card issuer.

In an embodiment of the method of FIG. 7, the information or instructions that are transmitted from split payment server 308 to respective issuers of payment card accounts associated with a split payment transaction are routed to the respective payment card issuers by split payment switch 310 operating according to routing instructions received from split payment server 308.

Responsive to receiving the information transmitted at step 706, each receiving payment card issuer may initiate transfer of the specific payment tranche amount (within the total split payment transaction amount) that is associated with said payment card issuer from a payment card account of the payor to an identified recipient merchant account (for example, a merchant payment account associated with POS terminal 3046). Additionally, each receiving payment card issuer may store the received information identifying an installment repayment option(s) that has been offered by said payment card issuer to the payor in connection with the split payment transaction under implementation, and which installment repayment option has been accepted or selected by the payor in connection with the payment tranche associated with such payment card issuer. The payment card issuer subsequently uses this information to monitor and enforce the installment repayment plan or contract with the payor.

It would be understood that the methods of FIGS. 4 and 7 are intended to be used in combination for first obtaining authorization for, and thereafter implementing a split payment transaction. In one embodiment, the authorization steps (of FIG. 4) and the implementation steps (of FIG. 7) may be carried out in a time-phased manner—wherein a payor obtains advance authorization for a future split payment transaction (for example through a computing device or a smartphone) even before visiting a merchant for executing the transaction, and subsequently visits a merchant and provides instructions for executing the authorized split payment transaction from a merchant POS terminal.

In another embodiment, the authorization steps (of FIG. 4) and the transaction implementation steps (of FIG. 7) may be carried out within a single continuous process flow, wherein (i) a payor visits a merchant, and initiates a transaction payment workflow by presenting at least one payment card for payment of a transaction amount, at a POS terminal, (ii) the POS terminal presents the payor with an option of implementing the payment as a split payment transaction, (iii) the payor thereafter obtains authorization for the split payment transaction according to the method steps of FIG. 4, and may select for repayment, one or more repayment installment plans that have been offered to the payor by one or more of the payment card issuers involved in the split payment transaction, and (iv) the POS terminal thereafter proceeds to send out an instruction for implementing the authorized split payment transaction—which triggers the process flow described above in connection with FIG. 7.

FIG. 8 illustrates communication flow between network system entities for implementing the method of FIG. 7.

Step 8002 comprises receiving at POS terminal 802 payment transaction execution instructions—which may include (i) information identifying at least a payment card or payment card account intended to be used for the purposes of the payment transaction (for example, through a card-swipe event at a magnetic stripe reader of the POS terminal or through a card-tap event at a wireless card reader of the POS terminal or through other input that identifies a payment card account number), and (ii) optionally one or more additional payment transaction parameters including a payment amount, a merchant identifier, and payor identity authentication information (for example, a password, passcode, on-time-password (OTP) or personal identification number (PIN)).

At step 8004, the information received at step 8002 may be transmitted onward to split payment server 804.

Split payment server 804 thereafter confirms based on data records maintained by it (for example within data records stored in accordance with step 410 of FIG. 4), whether the payment transaction execution instruction relates to a split payment transaction that has been authorized in accordance with the method of FIG. 4. Responsive to positive confirmation that the transaction is a split payment transaction, split payment server 804 (i) identifies a payment card issuer corresponding to each payment card or payment card account involved in the approved split payment transaction, and (ii) retrieves installment repayment information corresponding to one or issuer specific payment tranches associated with the split payment transaction under implementation.

Step 8006 comprises transmitting from split payment server 804 to split transaction switch 806, the payment transaction information, installment information and issuer information corresponding to the split payment transaction under execution. Thereafter split transaction switch 806 (i) at step 8008 routes payment instructions to each issuer responsible for payment of a payment tranche within the overall split payment transaction, instructing said issuer to transfer the corresponding payment tranche for which it is responsible, to a merchant account, (ii) at step 8010 routes to one or more issuers involved in the split payment transaction, information identifying an installment repayment option(s) that has been offered by said issuer to the payor in connection with the split payment transaction under implementation, and which installment repayment option has been accepted or selected by the payor in connection with the payment tranche associated with such payment card issuer, and (iii) at step 8012 receives from the issuer(s) involved in implementing the split payment transaction, confirmation that payment of their respective payment tranches has been made to the merchant account.

Step 8014 comprises transmission of payment confirmation of each individual payment tranche within the split payment transaction, from split transaction switch 806 to split payment server 804—and the received confirmation information may thereafter be stored by split payment server 804 (preferably in a data record associated with the split transaction payment). Step 8016 comprises transmission of payment confirmation of the total split payment transaction amount from split payment server 804 to POS terminal 802—where the payment confirmation may be displayed to the payor and/or merchant.

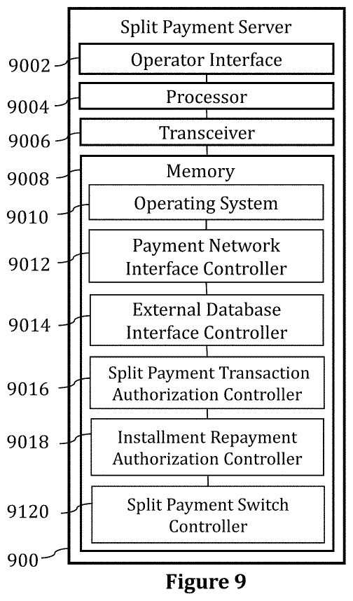

FIG. 9 illustrates an exemplary embodiment of a split payment server 900 of the type more generally illustrated in FIG. 3.

Split payment server 900 may comprise any processor implemented server device or data processing device configured for network based communication. In specific embodiments, split payment server 900 may include operator interface 9002, processor 9004, communication transceiver 9006 and memory 9008, which memory 9008 may include transitory memory and/or non-transitory memory. In an exemplary embodiment, memory 9008 may have stored therewithin, (i) an operating system 9010 configured for managing device hardware and software resources and that provides common services for software programs implemented within split payment server 900, (ii) a payment network interface controller 9012 configured to enable data to be received from and sent to a payment network, (iii) an external database interface controller 9014, configured to store at and retrieve from an external database, information corresponding to (a) approved split payment transactions and (b) installment repayment option(s) selected by a payor in connection with any approved split payment transaction, (iv) a split payment transaction authorization controller 9016, configured to obtain from concerned issuer institutions, authorizations for individual tranches of a split payment transaction requested by a payor, (v) an installment repayment authorization controller 9018, configured to obtain from concerned issuer institutions, installment payment options or arrangements that such issuer institutions are willing to offer a payor in connection with a split payment transaction, and further to receive from the concerned payor a selection of the offered installment payment options that said payor accepts for the purpose of the split payment transaction, and (vi) a split payment switch controller 9120, configured to interface with a split payment switch and provide said split payment switch with instructions for routing of payment instructions associated with a split payment transaction to the respective issuer institutions involved in said transaction.

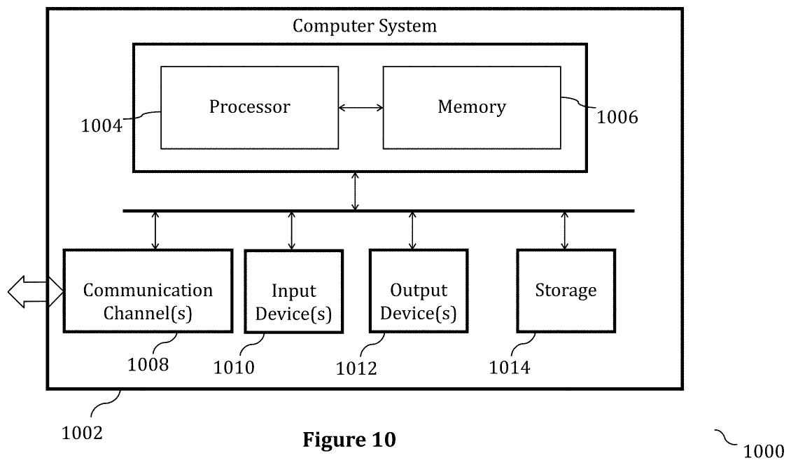

FIG. 10 illustrates an exemplary system 1000 for implementing the present invention.

System 1000 includes computer system 1002 which in turn comprises one or more processors 1004 and at least one memory 1006. Processor 1004 is configured to execute program instructions—and may be a real processor or a virtual processor. It will be understood that computer system 1002 does not suggest any limitation as to scope of use or functionality of described embodiments. The computer system 1002 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 1002 in accordance with the present invention may include one or more servers, desktops, laptops, tablets, smart phones, mobile phones, mobile communication devices, tablets, phablets and personal digital assistants. In an embodiment of the present invention, the memory 1006 may store software for implementing various embodiments of the present invention. The computer system 1002 may have additional components. For example, the computer system 1002 may include one or more communication channels 1008, one or more input devices 1010, one or more output devices 1012, and storage 1014. An interconnection mechanism (not shown) such as a bus, controller, or network, interconnects the components of the computer system 1002. In various embodiments of the present invention, operating system software (not shown) provides an operating environment for various softwares executing in the computer system 1002 using a processor 1004, and manages different functionalities of the components of the computer system 1002.

The communication channel(s) 1008 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1010 may include, but is not limited to, a touch screen, a keyboard, mouse, pen, joystick, trackball, a voice device, a scanning device, or any another device that is capable of providing input to the computer system 1002. In an embodiment of the present invention, the input device(s) 1010 may be a sound card or similar device that accepts audio input in analog or digital form. The output device(s) 1012 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 1002.

The storage 1014 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1002. In various embodiments of the present invention, the storage 1014 may contain program instructions for implementing any of the described embodiments.

In an embodiment of the present invention, the computer system 1002 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1002. The method described herein is typically implemented as a computer program product, comprising a set of program instructions that is executed by the computer system 1002 or any other similar device. The set of program instructions may be a series of computer readable codes stored on a tangible medium, such as a computer readable storage medium (storage 1014), for example, diskette, CD-ROM, ROM, flash drives or hard disk, or transmittable to the computer system 1002, via a modem or other interface device, over either a tangible medium, including but not limited to optical or analogue communications channel(s) 1008. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be apparent that the present invention offers significant advantages by enabling a payor to avail of installment repayment facilities while making a transaction payment through a split payment transaction arrangement—including increasing the number and value of payment transactions that a payment card account holder is capable of carrying out, as well as increasing merchant, issuer and payment network revenues as a consequence of the corresponding increase in payment transactions that the payment card account holder is enabled to enter into.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

1. A system for implementing a payment transaction split across a plurality of payment card accounts, comprising:
a processor implemented split payment server configured to:
receive from a terminal device, information describing a payment transaction for implementation based on the plurality of payment card accounts, said information including at least (i) information identifying a total payment transaction amount, (ii) information identifying the plurality of payment card accounts, and (iii) information identifying payment tranches within the total payment transaction amount that is intended to be paid from each of the identified plurality of payment card accounts;
obtain from each issuer respectively associated with each of the plurality of payment card accounts, issuer authorization for disbursement of a payment tranche that comprises part of the total payment transaction amount that is intended to be paid from said payment card account;
obtain from one or more issuers associated with one or more of the plurality of payment card accounts, information defining one or more installment repayment arrangements offered by said one or more issuers in connection with the payment tranches that have been authorized for disbursement by said one or more issuers;
receive from the terminal device, information identifying one or more of the installment repayment arrangements that have been accepted by a payor; and
retrievably store in a database, the information describing the payment transaction and the information identifying the one or more installment repayment arrangements that have been accepted by the payor.

2. The system as claimed in claim 1, wherein the information describing the payment transaction for implementation based on the plurality of payment card accounts, includes information comprising (i) a payor identifier, (ii) a merchant identifier or merchant account identifier, and (iii) information indicating that payment transaction is a payment transaction intended to be split across a plurality of payment card accounts.

3. The system as claimed in claim 1, wherein:
the one or more installment repayment arrangements offered by one or more issuers in connection with the payment tranches that have been authorized for disbursement by said one or more issuers are transmitted to the terminal device for display to the payor; and
the information identifying one or more of the installment repayment arrangements that have been accepted by the payor, is received through inputs at the terminal device.

4. The system as claimed in claim 1, wherein the split payment server is configured to:
receive from a point-of-sale (POS) terminal, a payment transaction execution instruction; and
responsive to determining that the payment transaction execution instruction corresponds to a stored payment transaction authorization relating to a payment transaction intended to be split across a plurality of payment card accounts:
identify a payment card issuer corresponding to each payment card account involved in the authorized payment transaction;
retrieve installment repayment information corresponding to one or more issuer specific payment tranches associated with the authorized payment transaction;
transmit to each identified payment card issuer, a payment implementation request, for implementing transfer of the specific payment tranche amount associated with said payment card issuer, from a payment card account of the payor to a merchant account; and
transmit to at least one of said payment card issuers associated with individual payment tranches, information identifying an installment repayment arrangement that has been offered by said payment card issuer to the payor and which installment repayment arrangement has been accepted by the payor in connection with the payment tranche associated with such payment card issuer.

5. The system as claimed in claim 4, wherein the payment transaction execution instruction includes one or more of information identifying one or more payment card accounts, a payment amount, a merchant identifier, and payor identity authentication information.

6. The system as claimed in claim 4, wherein a determination that the payment transaction execution instruction corresponds to a stored payment transaction authorization relating to a payment transaction intended to be split across a plurality of payment card accounts, is based on identifying a match between data parameters corresponding to the payment transaction execution instruction and data parameters corresponding to one or more stored payment transaction authorizations relating to payment transactions intended to be split across a plurality of payment card accounts.

7. A method for implementing a payment transaction split across a plurality of payment card accounts, comprising, at a split payment server:
receiving from a terminal device, information describing a payment transaction for implementation based on the plurality of payment card accounts, said information including at least (i) information identifying a total payment transaction amount, (ii) information identifying the plurality of payment card accounts, and (iii) information identifying payment tranches within the total payment transaction amount that is intended to be paid from each of the identified plurality of payment card accounts;
obtaining from each issuer respectively associated with each of the plurality of payment card accounts, issuer authorization for disbursement of a payment tranche that comprises part of the total payment transaction amount that is intended to be paid from said payment card account;
obtaining from one or more issuers associated with one or more of the plurality of payment card accounts, information defining one or more installment repayment arrangements offered by said one or more issuers in connection with the payment tranches that have been authorized for disbursement by said one or more issuers;
receiving from the terminal device, information identifying one or more of the installment repayment arrangements that have been accepted by a payor; and
retrievably storing in a database, the information describing the payment transaction and the information identifying the one or more installment repayment arrangements that have been accepted by the payor.

8. The method as claimed in claim 7, wherein the information describing the payment transaction for implementation based on the plurality of payment card accounts, includes information comprising (i) a payor identifier, (ii) a merchant identifier or merchant account identifier, and (iii) information indicating that payment transaction is a payment transaction intended to be split across a plurality of payment card accounts.

9. The method as claimed in claim 7, wherein:
the one or more installment repayment arrangements offered by one or more issuers in connection with the payment tranches that have been authorized for disbursement by said one or more issuers are transmitted to the terminal device for display to the payor; and
the information identifying one or more of the installment repayment arrangements that have been accepted by the payor, is received through inputs at the terminal device.

10. The method as claimed in claim 7, comprising:
receiving from a point-of-sale (POS) terminal, a payment transaction execution instruction; and
responsive to determining that the payment transaction execution instruction corresponds to a stored payment transaction authorization relating to a payment transaction intended to be split across a plurality of payment card accounts:
identifying a payment card issuer corresponding to each payment card account involved in the authorized payment transaction;
retrieving installment repayment information corresponding to one or more issuer specific payment tranches associated with the authorized payment transaction;
transmitting to each identified payment card issuer, a payment implementation request, for implementing transfer of the specific payment tranche amount associated with said payment card issuer, from a payment card account of the payor to a merchant account; and
transmitting to at least one of said payment card issuers associated with individual payment tranches, information identifying an installment repayment arrangement that has been offered by said payment card issuer to the payor and which installment repayment arrangement has been accepted by the payor in connection with the payment tranche associated with such payment card issuer.

11. The method as claimed in claim 10, wherein the payment transaction execution instruction includes one or more of information identifying one or more payment card accounts, a payment amount, a merchant identifier, and payor identity authentication information.

12. The method as claimed in claim 10, wherein a determination that the payment transaction execution instruction corresponds to a stored payment transaction authorization relating to a payment transaction intended to be split across a plurality of payment card accounts, is based on identifying a match between data parameters corresponding to the payment transaction execution instruction and data parameters corresponding to one or more stored payment transaction authorizations relating to payment transactions intended to be split across a plurality of payment card accounts.
